(19) United States
(12) Patent Application Publication
(10) Pub. No.: US 2014/0355166 A1
(43) Pub. Date: Dec. 4, 2014

(54) Antenna Connecting Device

(71) Applicant: Shan-Gow Lo, Tainan City (TW)

(72) Inventor: Shan-Gow Lo, Tainan City (TW)

(21) Appl. No.: 13/909,135

(22) Filed: Jun. 4, 2013

(51) Int. Cl. H02G 13/00

(52) U.S. Cl. CPC H02G 13/80
USPC 361/220

(57) ABSTRACT

An antenna connection device contains a receiving end, a discharge tube, a first aluminum box, a second aluminum box a copper post, and a device end. The receiving end is a connector for connecting with an antenna and has a copper post extending outwardly from an inner side thereof so as to connect with the discharge tube, and a distal end of the copper post couples with a capacitance so as to conduct electricity to the device end, between the receiving end and the device end are defined a first recess and a second recess corresponding to the first aluminum box and the second aluminum box, wherein between the first recess and the second recess is defined a quadrilateral space so that the copper post, the discharge tube, and the capacitance are covered in the first aluminum box and the second aluminum.

### FIELD OF THE INVENTION

The present invention relates to an antenna connecting device which has an anti-lightning function and stops DC current so as to prevent electronic product from being damaged by lightning.

### BACKGROUND OF THE INVENTION

With reference to FIG. 1, one end of an antenna is coupled with a conventional lightning protection device 1 so as to conduct transient surge out of an electronic product.

Likewise, the lightning protection device 1 is connected with the antenna and the electronic product so that signals are transmitted to the electronic product from the antenna via the lightning protection device 1. The lightning protection device 1 has a ground end 11 fixed on a bottom end thereof so as to connect the lightning protection device 1 with a grounding wire. Referring further to FIG. 2, the receiving end 12 has a central needle 120 mounted therein, and a discharging tube 13 and a capacitance 14 are disposed on the central needle 120, a copper piece 140 extends outwardly from the capacitance 14 so that the cable conducts with a device end 15, hence when lightning hits the antenna, instantaneous high voltage or current is conducted out of the discharging tube 13.

As shown in FIG. 3, two aluminum boxes 16, 160 are connected together to form a block, and two semi-circular arcuations 161, 1601 are defined on the two aluminum boxes 16, 160, so when the aluminum boxes 16, 160 are connected together, a circular gap forms so as to use as an incidence rate and a reflectivity rate of electric wave. However, the VSWR of the lightning protection device 1 is poor, so when the signals receive or transmit, they are interfered easily.

The present invention has arisen to mitigate and/or obviate the afore-described disadvantages.

### SUMMARY OF THE INVENTION

The primary object of the present invention is to provide an antenna connecting device which has an anti-lightning function and stops DC current so as to prevent electronic product from being damaged by lightning.

To obtain the above objectives, an antenna connecting device contains a receiving end, a discharge tube, a first aluminum box, a second aluminum box a copper post, and a device end.

The receiving end is a connector for connecting with an antenna and has a copper post extending outwardly from an inner side thereof so as to connect with the discharge tube, and a distal end of the copper post couples with a capacitance so as to conduct electricity to the device end, between the receiving end and the device end are defined a first recess and a second recess corresponding to the first aluminum box and the second aluminum box, wherein between the first recess and the second recess is defined a quadrilateral space so that the copper post, the discharge tube, and the capacitance are covered in the first aluminum box and the second aluminum.

Thereby, the first recess has two first guiding angles formed on the two corners thereof, the second recess have two second guiding angles formed on the two corners thereof so that between the first aluminum box and the second aluminum box are defined the two gaps to obtain incidence rate and reflectivity rate have ideal VSWR, and the ratio of two VSWR is 1.1:1. Furthermore, the copper post extends to the device end, so the capacitance is eliminated from the device end, this lowering production cost and having anti-lightning function.

### BRIEF DESCRIPTION OF THE DRAWINGS

FIG. 1 is a perspective view of a conventional lightning protection device.

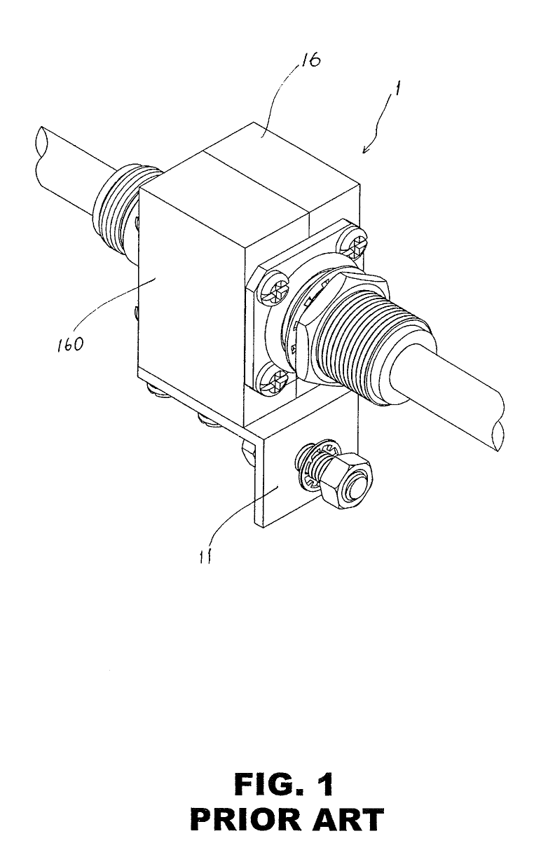

FIG. 2 is a plan view of the conventional lightning protection device.

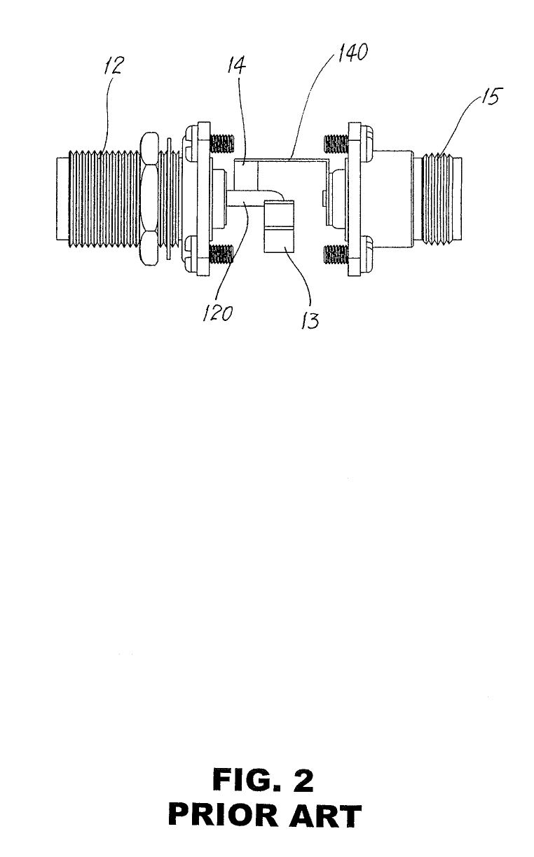

FIG. 3 is a plan view of an aluminum box of the conventional lightning protection device.

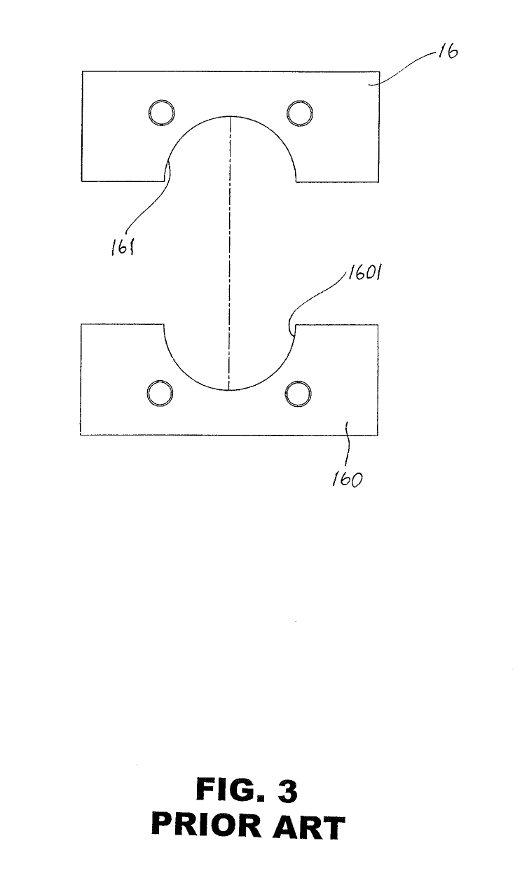

FIG. 4 is a perspective view showing the exploded components of an antenna connection device according to a preferred embodiment of the present invention.

FIG. 5 is a plan view of an aluminum box of the antenna connection device according to the preferred embodiment of the present invention.

FIG. 6 is a perspective view showing the assembly of the antenna connection device according to the preferred embodiment of the present invention.

FIG. 7 is a side plan view showing the assembly of the antenna connection device according to the preferred embodiment of the present invention.

FIG. 8 is a perspective view showing the operation of the antenna connection device according to the preferred embodiment of the present invention.

### DETAILED DESCRIPTION OF THE PREFERRED EMBODIMENTS

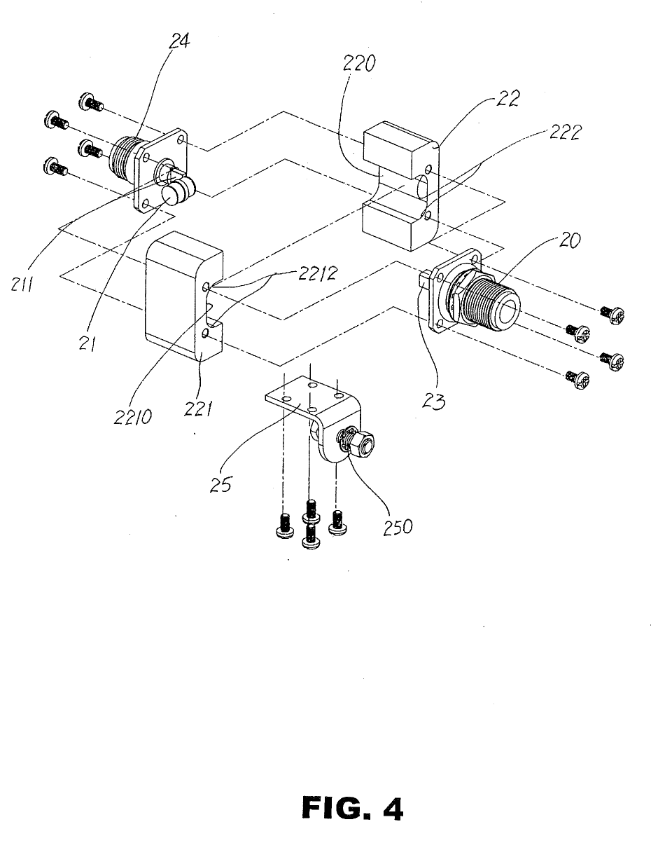

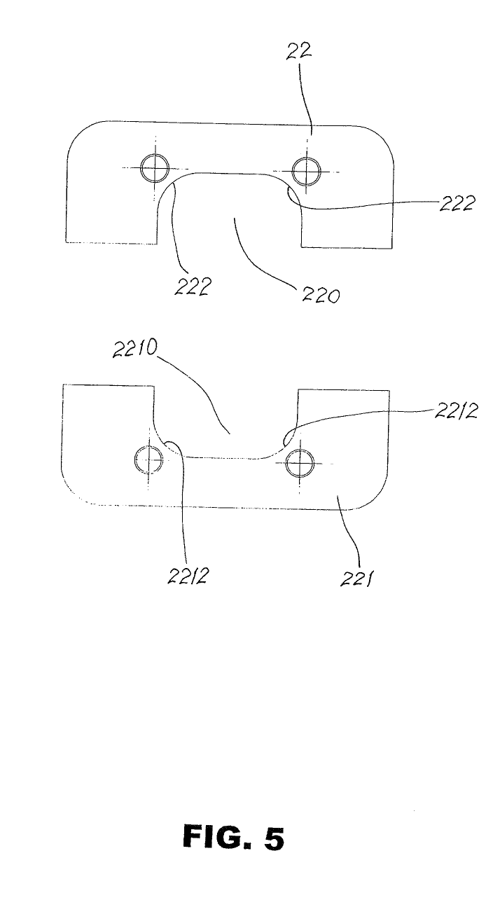

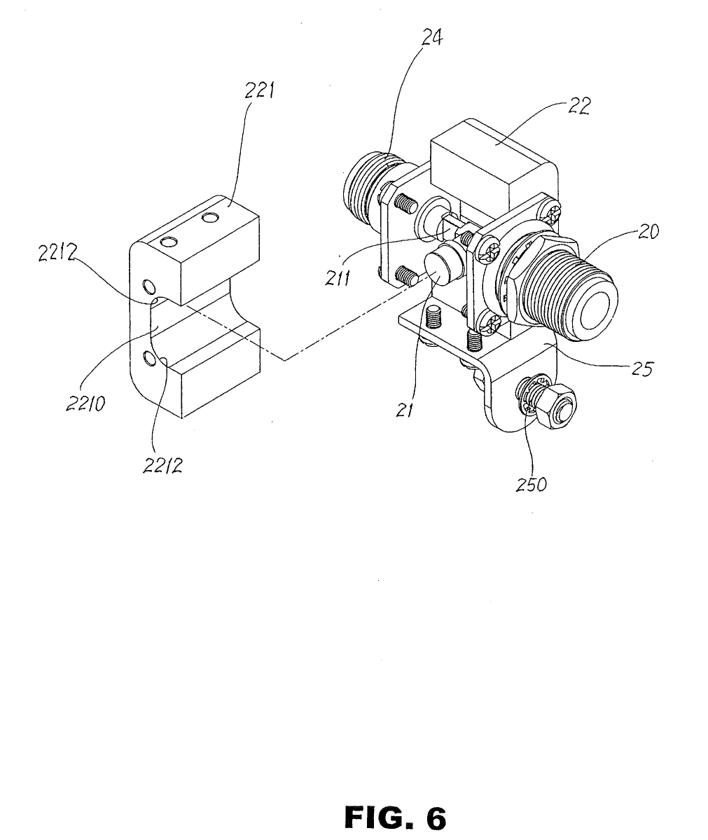

FIG. 4 is a perspective view showing the exploded components of an antenna connection device according to a preferred embodiment of the present invention. An antenna connection device according to a preferred embodiment of the present invention comprises a receiving end 20, a discharge tube 21, a first aluminum box 22, a second aluminum box 221, a copper post 23, and a device end 24. The receiving end 20 is a connector for connecting with an antenna and has a copper post 23 extending outwardly from an inner side thereof so as to connect with the discharge tube 21, such that electric current generating from instantaneous high voltage is conducted to a ground end 250, and a distal end of the copper post 23 couples with a capacitance 211 so as to conduct electricity to the device end 24, hence signals received by the receiving end 20 are transmitted to the device end 24, thereafter an electronic product receives the signals via the device end 24. Also, the capacitance 211 stops DC currents so as to prevent the device end 24 from being damaged by high voltage or currents. Between the receiving end 20 and the device end 24 are defined a first recess 220 and a second recess 2210 corresponding to the first aluminum box 22 and the second aluminum box 221 (as shown in FIG. 5), wherein between the first recess 220 and the second recess 2210 is defined a quadrilateral space so that the copper post 23, the discharge tube 21, and the capacitance 211 are covered in the first aluminum box 22 and the second aluminum 221. The first recess 220 has two first guiding angles 222 formed on two corners thereof, the second recess 2210 have two second guiding angles 2212 formed on two corners thereof so that between the first aluminum box 22 and the second aluminum box 221 are defined two gaps to obtain incidence rate and reflectivity rate have ideal VSWR, and their insertion loss is less than 0.1 dB, such that power tolerance of the antenna is higher. In addition, the discharging tube 21 and an aluminum box 221 are connected together. Referring further to FIG. 6, the second aluminum box 221 couples with a grounding piece 25 with the ground end 250 so as to conduct electric current of the discharging tube 21 out of the ground end 250, thus releasing transient voltage surge. Accordingly, the electronic product (such as computer, television and the like) connecting with the device end 24 will not be damaged by lightning.

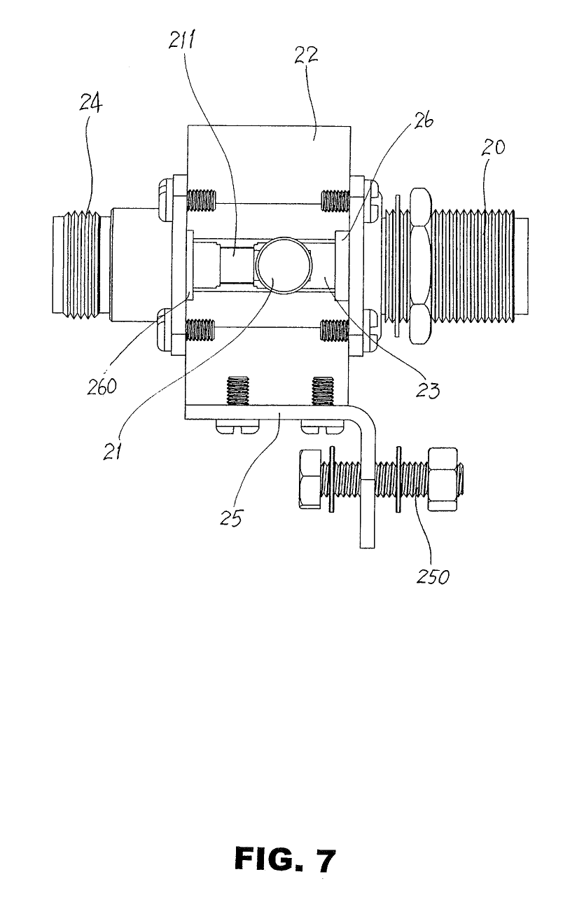

FIG. 7 is a side plan view showing the assembly of the antenna connection device according to the preferred embodiment of the present invention. The receiving end 20 is in connection with the antenna so as to receive the signals and is coupled with the copper post 23 so as to conduct electric wave to the capacitance 211 via the copper post 23, thus conducting electricity to the electronic product via the device end 24. Also, the capacitance 211 stops DC currents so as to prevent the device end 24 from being damaged by high voltage or currents. The copper post 23 couples with the discharging tube 21 so that the electric current generating from the instantaneous high voltage is conducted to the grounding piece 25 (as shown in FIG. 6) and is discharged from a ground wire connecting with the ground end 250 of the grounding piece 25, thus preventing the electronic product from being damaged by lightning. Referring back to FIG. 5, between the receiving end 20 and the device end 24 are defined a first recess 220 and a second recess 2210 corresponding to the first aluminum box 22 and the second aluminum box 221, and between the first recess 220 and the second recess 2210 is defined the quadrilateral space so that the copper post 23, the discharge tube 21, and the capacitance 211 are covered in the first aluminum box 22 and the second aluminum 221, and between the receiving end 20 and the copper post 23 is fitted a first insulation sleeve 26, between the device end 24 and the copper post 23 is fitted a second insulation sleeve 260 so that the two gaps of the first aluminum box 22 and the second aluminum box 221 has ideal incidence rate and reflectivity rate, and the incidence rate and the reflectivity rate have ideal VSWR by ways of the two first guiding angles 222 and the two second guiding angles 2212, wherein a ratio of two VSWR is 1.1:1. Furthermore, the copper post 23 extends to the device end 24, so capacitance 211 is eliminated from the device end 24, this lowering production cost and having anti-lightning function.

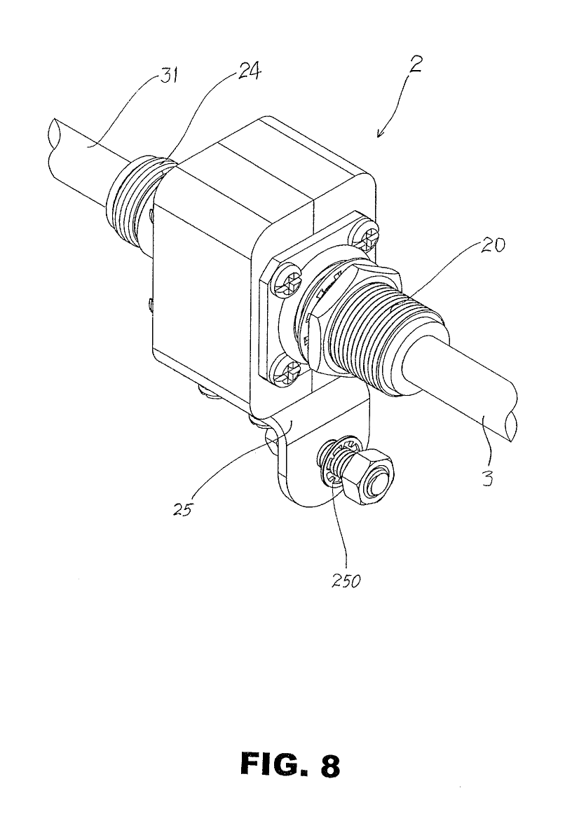

FIG. 8 is a perspective view showing the operation of the antenna connection device according to the preferred embodiment of the present invention. The antenna 3 couples with the receiving end 20 so as to receive the signals, and the device end 24 is in connection with the electronic product via a cable 31 so that the signals received by the antenna 3 is inputted to the electronic product, and a connecting device 2 has the discharge tube 21 (not shown) fixed therein. When the antenna 3 is hit by the lightning, the electric current generating from instantaneous high voltage is conducted to the ground end 250 of the grounding piece 25, thus releasing transients and surges, and the capacitance 211 stops the DC currents so as to prevent the device end 24 from being damaged.

Thereby, the first recess 220 has two first guiding angles 222 formed on the two corners thereof, the second recess 2210 have two second guiding angles 2212 formed on the two corners thereof so that between the first aluminum box 22 and the second aluminum box 221 are defined the two gaps to obtain incidence rate and reflectivity rate have ideal VSWR, and the ratio of two VSWR is 1.1:1. Furthermore, the copper post 23 extends to the device end 24, so the capacitance 211 is eliminated from the device end 24, this lowering production cost and having anti-lightning function.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An antenna connection device comprising:
a receiving end, a discharge tube, a first aluminum box, a second aluminum box a copper post, and a device end;
wherein the receiving end is a connector for connecting with an antenna and has a copper post extending outwardly from an inner side thereof so as to connect with the discharge tube, and a distal end of the copper post couples with a capacitance so as to conduct electricity to the device end, between the receiving end and the device end are defined a first recess and a second recess corresponding to the first aluminum box and the second aluminum box, wherein between the first recess and the second recess is defined a quadrilateral space so that the copper post, the discharge tube, and the capacitance are covered in the first aluminum box and the second aluminum.

2. The antenna connection device as claimed in claim 1, wherein the copper post extends to the device end so as to conduct electricity.
